(19) United States
(12) Patent Application Publication
(10) Pub. No.: US 2010/0245390 A1
(43) Pub. Date: Sep. 30, 2010

(54) System And Method For Automatic Monitor Orientation Without Information Handling System Host Polling

(76) Inventors: Joe Goodart, Austin, TX (US); Shuguang Wu, Austin, TX (US)

Correspondence Address: HAMILTON & TERRILE, LLP, P.O. BOX 203518, AUSTIN, TX, 78720, US

(21) Appl. No.: 12/414,020

(22) Filed: Mar. 30, 2009

(51) Int. Cl. G09G 5/00

(52) U.S. Cl. 345/649

(57) ABSTRACT

Visual images presented on an information handling system display automatically adjust to changes in the orientation of the display. An orientation device on the display detects changes in display orientation and sends an interrupt to an information handling system orientation module. The orientation module responds to the interrupt by retrieving orientation information from the display and adjusting the visual images to align with the orientation of the display.

### BACKGROUND OF THE INVENTION

1. Field of the Invention

The present invention relates in general to the field of information handling system display presentation, and more particularly to a system and method for automatic monitor orientation without information handling system host polling.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One information handling system improvement that has occurred over the past several years is the presentation of information by flat panel displays, such as liquid crystal displays (LCDs) or plasma displays. LCDs are typically much more energy efficient than the cathode ray tube (CRT) displays that LCDs replaced. Initially LCDs were used in portable information handling systems, such as laptops and cell phones. As the price of LCDs decreased, end users adopted LCDs as a replacement for CRT displays used in desktop or other types of non-portable information handling systems. In addition to having better energy efficiency, LCDs take up less room on the desktop and weigh less so that an end user can easily move the display to different positions as desired. Often, LCDs are mounted on movable brackets that give end users considerable freedom for selecting a display position. LCD mounting devices allow positioning of the display relative to an end user and also allow rotation of the display between portrait and landscape orientations. In some instances, LCD mounting devices allow an end user to flip a display so that the display is oriented upside down and backwards relative to the end user's view position. For example, an end user flips the display to show the display presentation to another user sitting opposite the end user. Various display orientations are available with pivoting hardware hinges of VESA compliant arm or wall mounts.

One difficulty with mounting flat panel displays on movable brackets is that the image presented on the display needs adjustment as the orientation of the display changes. For example, an end user who flips a display to present information to an individual opposite the end user also needs to adjust the information presented on the display or the viewer will see the image upside down. To adjust the image, an end user can usually interact with the display contents through a graphical user interface or other access to the graphics driver of the information handling system. In some instances, rotatable display monitors have sensors that detect a display's orientation and relay the orientation to the information handling system so that the information handling system can automatically adjust the orientation of images presented at the display to match the orientation of the display. One example of such automatic display orientation is the use of an accelerometer in a cell phone so that the display is always oriented opposite the acceleration of gravity. Automatic orientation of display content in desktop systems is accomplished by the information handling system polling the display to detect when a change in orientation occurs. For example, such polling is used by EzTune, a proprietary orientation system developed by PortraitDisplay. However, frequent polling to detect orientation changes reduces display performance while infrequent polling delays display orientation changes with excess latency that compromises the end user experience.

### SUMMARY OF THE INVENTION

Therefore a need has arisen for a system and method which rapidly adjusts the orientation of display contents to changes in display orientation with minimal communication overhead.

In accordance with the present invention, a system and method are provided which substantially reduce the disadvantages and problems associated with previous methods and systems for detecting changes in display orientation and adjusting display content orientation to changes in display orientation. Upon detection of a change in display orientation, the display sends an interrupt to an information handling system. The information handling system responds to the interrupt by retrieving the display orientation from the display for aligning visual information presented at the display to adjust for the display orientation.

More specifically, a display includes an orientation device that detects changes in display orientation. Upon detection of a change in orientation, the orientation device initiates an interrupt for communication to an interfaced information handling system. For example, a controller in the display sets values in display registers that indicate the display orientation and then sends a hot plug detect short pulse to the information handling system. An orientation module on the information handling system retrieves values from the registers in response to the hot plug detect to determine that the interrupt indicates a change in orientation and then retrieves the current orientation value. The orientation module adjusts visual information provided to the display to align visual images presented at the display with a desired orientation, such as a vertical or upright orientation independent of the display orientation.

The present invention provides a number of important technical advantages. One example of an important technical advantage is that the orientation of display contents is automatically adjusted to changes in display orientation with minimal response time and relatively little system overhead. Instead of polling by an information handling system to detect changes in display orientation, an interrupt is provided by the display to the information handling system to indicate a change in display orientation. The information handling system responds to the interrupt by retrieving the display orientation, thus reducing system overhead by reducing or eliminating the need for polling of the display by the information handling system while providing a rapid response in adjusting display content orientation.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having automatic display image orientation;

FIG. 2 depicts a flow diagram of a process for communication of orientation changes from a display; and

FIG. 3 depicts a flow diagram of a process for communication of orientation changes to an information handling system.

### DETAILED DESCRIPTION

Automatic adjustment of display content orientation to display orientation with an interrupt sent to an information handling system provides a rapid response time with minimal system overhead. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

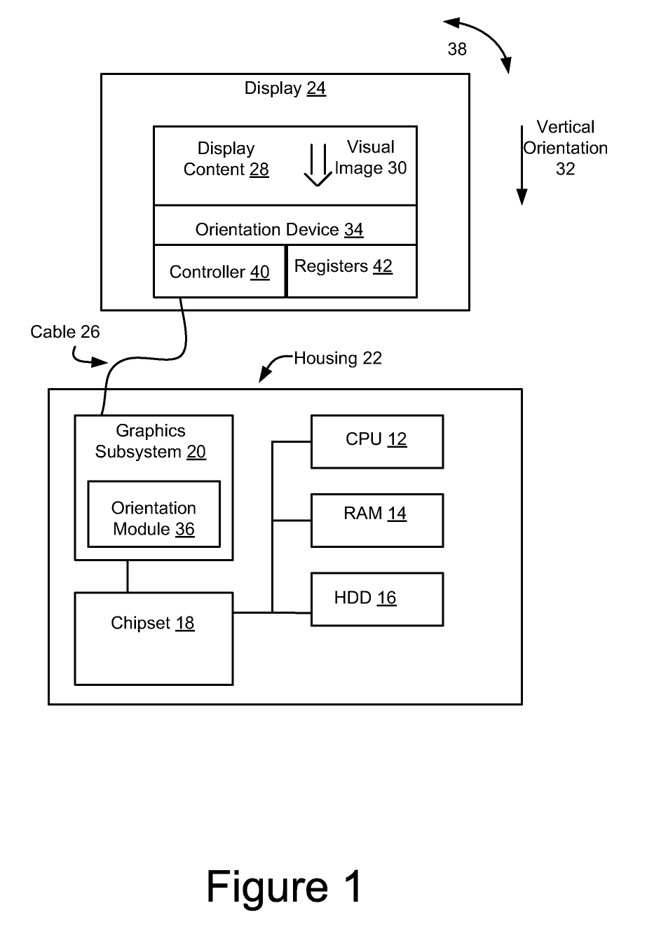

Referring now to FIG. 1, a block diagram depicts an information handling system 10 having automatic display image orientation. Information handling system 10 has plural processing components that cooperate to process information, such as a CPU 12, RAM 14, a hard disk drive 16, a chipset 18 and a graphics subsystem 20. The processing components are disposed in a housing 22 and communicate with a display 24 through a cable 26, such as by communication protocols defined in the DisplayPort standard. The processing components cooperate to generate visual information for presentation at display 24 as visual images. For example, instructions stored in hard disk drive 16 are executed by CPU 12 in cooperation with RAM 14 or other computer readable media. The visual information is provided to graphics subsystem 20 for processing to generate electronic signals that result in presentation of visual images as display content 28 presented at display 24, such as by an LCD panel.

Graphics subsystem 20 manages visual information sent to display 24 so that visual images presented as display content 28 are oriented in a desired direction. In the example embodiment depicted by FIG. 1, display content 28 includes an arrow visual image 30 having a vertical orientation 32 aligned with acceleration of gravity. An orientation device 34 detects an orientation of display 24 relative to a predetermined orientation axis. For example, orientation device 34 is an accelerometer that detects the orientation of display 24 relative to a vertical orientation 32 aligned with gravitational acceleration. An orientation module 36 running on a processing component of information handling system 10, such as chipset 18 or graphics subsystem 20, detects changes in the orientation of display content 28, such as visual image 30, and adjusts visual information sent to display 24 to maintain display content 28 aligned with a desired orientation, such as vertical orientation 32, as display 24 rotates as depicted by arrows 38.

In the example embodiment depicted by FIG. 1, display 24 and information handling system 10 communicate according to the DisplayPort standard. In order to maintain a vertical or other desired orientation of visual image 30 during rotation of display 24 about axis 38, a controller 40 and registers 42 cooperate with orientation device 34 to communicate display orientation information to orientation module 36 of graphics subsystem 20. For example, if orientation device 34 detects a change in orientation, then an interrupt is sent from controller 40 to orientation module 36 to indicate that a change of display orientation has occurred. For instance, a hot plug detect short pulse is sent as an interrupt from display 24 to information handling system 10. The DisplayPort IRQ and associated IRQ vector in a DisplayPort Configuration Data (DPCD) register 42 are initiated by controller 40 through a hot plug detect (HPD) short pulse as specified in the DisplayPort 1.1 specification so that the DPCD IRQ register 42 allows the host to read information that indicates that the interrupt is to indicate a change in orientation. Using the VESA Monitor Control Command Set (MCCS), a new control value Virtual Control Panel (VCP) 02h combined with active control VCP 52h allows orientation module 36 to determine the type of parameter change, such as an orientation change, indicated by the IRQ. Once orientation module 36 reads the display orientation from display 24, visual images generated at the display are reoriented to maintain a desired alignment, such as a vertical orientation so that the visual image appears upright as display 24 rotates about axis 38.

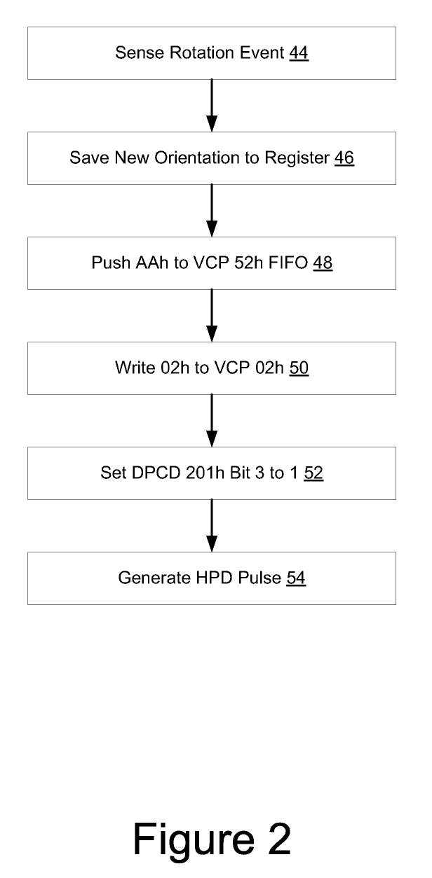

Referring now to FIG. 2, a flow diagram depicts a process for communication of orientation changes from a display. The process begins at step 44 with the occurrence of a rotation event at the display detected by the orientation device. At step 46, the new display orientation is saved to a register of the display. At step 48, AAh is pushed to the VCP 52h FIFO and, at step 50, 02h is written to VCP 02h register. The VCP settings will be read by the information handling system to determine that an orientation change has caused an interrupt to issue from the display. At step 52 the DPCD 201h Bit 3 is set to 1 and, at step 54, an HPD pulse is generated and sent through the display cable to the information handling system. Upon sending the HPD pulse, the display has set all values to be read by the information handling system for determining the orientation of the display.

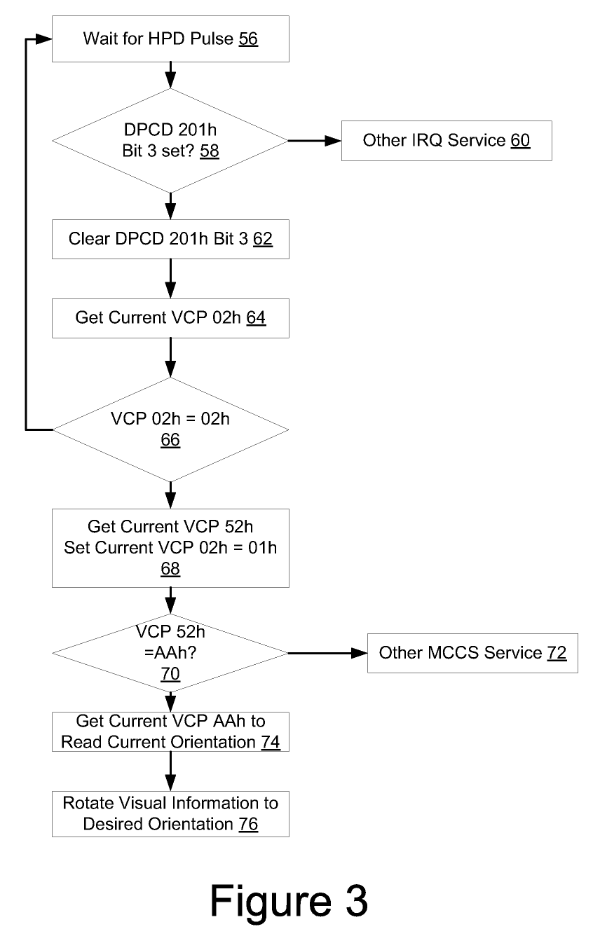

Referring now to FIG. 3, a flow diagram depicts a process for communication of orientation changes to an information handling system. The process begins at step 56 in a wait state for the HPD pulse. At step 58, at detection of the HPD pulse, a determination is made of whether the DPCD 201h bit 3 is set. If not, the process continues to step 60 to determine what other IRQ service is requested by the HPD interrupt. If yes, the process continues to step 62 to clear the DPCD 201h bit 3. At step 64, the information handling system retrieves the current VCP 02h value. At step 66, the information handling system determines if the current VCP 02h value is equal to 02h. If not, the process returns to step 56. If yes, the process continues to step 68 to get the current value for VCP 52h and set the value for VCP 02h to 01h. At step 70, a determination is made of whether VCP 52h is equal to value AAh. If not, the process continues to step 72 to determine the other MCCS service requested by the interrupt. If yes, the process continues to step 74 to get the current value for VCP AAh to read the current display orientation. At step 76, the visual information output from the information handling system is rotated so that visual images are output at a desired orientation, such as a vertical orientation.

Although the present invention has been described in detail, it should be understood that various changes, substitutions and alterations can be made hereto without departing from the spirit and scope of the invention as defined by the appended claims.

What is claimed is:

1. An information handling system comprising:
plural processing components operable to generate visual information;
a graphics subsystem interfaced with the processing components and operable to process the visual information for presentation as visual images at a display, the visual images having a selectable of plural orientations relative to the display; and
an orientation module running on a processing component, the orientation module operable to receive an orientation indication from the display, to retrieve orientation information from the display in response to the orientation indication and to adjust presentation of the visual images according to the orientation information.

2. The information handling system of claim 1 further comprising:
a display operable to present visual information as visual images;
a cable interfacing the display and the processing components; and
an orientation device operable to detect the orientation of the display, to send an orientation indication through the cable in response to changes in orientation of the display and to send orientation information through the cable in response to a query from the orientation module.

3. The information handling system of claim 2 wherein the orientation module comprises firmware instructions executing on the graphics subsystem.

4. The information handling system of claim 2 wherein the orientation indication comprises an interrupt sent from the display upon detection of a change in orientation at the display.

5. The information handling system of claim 2 wherein the orientation indication comprises a hot plug detect pulse.

6. The information handling system of claim 5 wherein the orientation module responds to the hot plug detect pulse by retrieving a value from an interrupt request register to determine that the hot plug detect pulse indicates a change in display orientation.

7. The information handling system of claim 6 wherein the orientation module responds to the interrupt request register by requesting orientation information from the display.

8. The information handling system of claim 7 wherein the orientation module requests orientation information by reading a control value from the display.

9. A method for presenting information at a display, the method comprising:
detecting a change in orientation at the display;
sending an orientation indication from the display to an information handling system in response to the detecting; and
querying the display from the information handling system for orientation information in response to the orientation indication.

10. The method of claim 9 further comprising:
responding to the querying by sending orientation information from the display to the information handling system; and
altering visual information sent from the information handling system to the display to adjust a visual image presented at the display according to the change in orientation at the display.

11. The method of claim 10 wherein altering visual information further comprise altering visual information so that visual images are presented at the display oriented to an upright vector.

12. The method of claim 9 wherein sending and querying comprise communications sent between separate information handling system and display housings through a cable.

13. The method of claim 9 wherein an orientation indication further comprises:
initiating an interrupt at the display upon detection of a change in orientation; and
sending the interrupt to the information handling system.

14. The method of claim 13 wherein the interrupt comprises a hot plug detect pulse.

15. The method of claim 13 wherein querying the display further comprises:
responding to the interrupt by reading an interrupt value from an interrupt register;
determining that the interrupt value indicates a change in orientation; and
reading orientation information in response to the interrupt value.

16. A system for automatic adjustment of images at a display to changes in orientation of the display, the system comprising:
an orientation device operable to detect changes in orientation of a display and to generate an interrupt in response to the changes; and
an orientation module interfaced with the display and operable to respond to the interrupt by requesting orientation information from the display.

17. The system of claim 16 wherein the interrupt comprises a hot plug device pulse.

18. The system of claim 16 wherein the orientation module is further operable to adjust visual information to align visual images formed from the visual information with the orientation of the display.

19. The system of claim 18 wherein the orientation device comprises an accelerometer that determines a vertical axis and the visual images align with the vertical axis.

20. The system of claim 19 wherein the orientation module comprises firmware executing on a graphics subsystem of an information handling system.
